(19) United States
(12) Patent Application Publication
(10) Pub. No.: US 2026/0154208 A1
(43) Pub. Date: Jun. 4, 2026

(54) MEMORY DEVICE

(71) Applicant: SAMSUNG ELECTRONICS CO., LTD., Suwon-si (KR)

(72) Inventors: Juhyung KIM, Suwon-si (KR); Wanki KIM, Suwon-si (KR)

(73) Assignee: SAMSUNG ELECTRONICS CO., LTD., Suwon-si (KR)

(21) Appl. No.: 19/264,465

(22) Filed: Jul. 9, 2025

(30) Foreign Application Priority Data
Dec. 3, 2024 (KR) 10-2024-0177156

(51) Int. Cl. G06F 13/10

(52) U.S. Cl. CPC G06F 13/10; G06F 2213/40

(57) ABSTRACT

A memory device includes a cell region including a plurality of channel structures; and a peripheral circuit region including peripheral circuits controlling the cell region. Each of the plurality of channel structures includes a back electrode layer, and a ferroelectric layer and a channel layer. In a program operation for a selected memory cell, the peripheral circuit region is configured to input a pass voltage to a selected word line and input a back bias voltage to the back electrode layer from a first point in time, maintain a voltage of the back electrode layer at the back bias voltage during a period from a second point in time to a third point in time after the first point in time, and input the pass voltage to unselected word lines, different from the selected word line after the third point in time.

### CROSS-REFERENCE TO RELATED APPLICATION(S)

This application claims the benefit under 35 USC 119(a) of Korean Patent Application No. 10-2024-0177156 filed in the Korean Intellectual Property Office on Dec. 3, 2024, the entire disclosure of which is incorporated herein by reference for all purposes.

### BACKGROUND

A memory device may provide the ability to write and erase data, or to read written data. A memory device may be divided into a non-volatile memory device and a volatile memory device, and the non-volatile memory device may retain written data even when a power supply thereto is cut off. As a type of non-volatile memory device, a memory device in which data can be written or erased by switching a polarization direction of a ferroelectric layer included in a memory cell has been proposed. In such a memory device, in a program operation to write data to the memory cell, a problem in which the polarization direction of the ferroelectric layer is not smoothly switched as an inversion layer is formed first in a channel layer of the memory cell, may occur.

### SUMMARY

An aspect of the present inventive concept is to provide a memory device having improved performance of a program operation by first inverting a polarization direction of a ferroelectric layer before an inversion layer is formed in a channel layer of a selected memory cell connected to a selected word line, by inputting a pass voltage to a selected word line and inputting a back bias voltage to a back electrode layer before inputting a pass voltage to unselected word lines in a program operation.

According to some example embodiments, a memory device includes a cell region including a plurality of word lines stacked on a substrate, and a plurality of channel structures extending in a first direction, perpendicular to the substrate and penetrating through the plurality of word lines; and a peripheral circuit region including peripheral circuits controlling the cell region. Each of the plurality of channel structures includes a back electrode layer extending in the first direction and electrically connected to a source region disposed on the substrate, and a ferroelectric layer and a channel layer extending in the first direction and sequentially disposed between the back electrode layer and the plurality of word lines in a direction, parallel to an upper surface of the substrate. In a program operation for a selected memory cell connected to a selected word line among the plurality of word lines, the peripheral circuit region is configured to input a pass voltage to the selected word line and input a back bias voltage to the back electrode layer from a first point in time, maintain a voltage of the back electrode layer at the back bias voltage during a period from a second point in time to a third point in time after the first point in time, and input the pass voltage to unselected word lines, different from the selected word line after the third point in time.

According to some example embodiment, a memory device includes a cell region including a plurality of word lines stacked on a substrate, and a plurality of channel structures extending in a first direction, perpendicular to the substrate and penetrating through the plurality of word lines; and a peripheral circuit region including peripheral circuits controlling the cell region. Each of the plurality of channel structures includes a back electrode layer extending in the first direction and electrically connected to a source region formed on the substrate, and a ferroelectric layer and a channel layer extending in the first direction and sequentially disposed between the back electrode layer and the plurality of word lines in a direction, parallel to an upper surface of the substrate. In a program operation for a selected memory cell connected to a selected word line among the plurality of word lines, the peripheral circuit region is configured to input a back bias voltage, lower than a ground voltage to the back electrode layer before inputting a pass voltage to unselected word lines, different from the selected word line, and set a difference between voltages of the unselected word lines and a voltage of the back electrode layer to be less than or equal to the pass voltage.

According to some example embodiment, a memory device includes a cell region including a plurality of word lines stacked on a substrate, and a plurality of channel structures extending in a first direction, perpendicular to the substrate and penetrating through the plurality of word lines; and a peripheral circuit region including peripheral circuits controlling the cell region. Each of the plurality of channel structures includes a back electrode layer extending in the first direction and electrically connected to a source region disposed on the substrate, and a ferroelectric layer and a channel layer extending in the first direction and sequentially disposed between the back electrode layer and the plurality of word lines in a direction, parallel to an upper surface of the substrate. In a program operation for a selected memory cell connected to a selected word line among the plurality of word lines, the peripheral circuit region is configured to input a positive voltage to the selected word line and input a negative voltage to the back electrode layer, while a ground voltage is input to unselected word lines, different from the selected word line, and a difference between the positive voltage and the negative voltage is greater than a voltage, required to invert a polarization direction of the ferroelectric layer of the selected memory cell.

### BRIEF DESCRIPTION OF DIAGRAMS

Example embodiments will be more clearly understood from the following detailed description, taken in conjunction with the accompanying drawings.

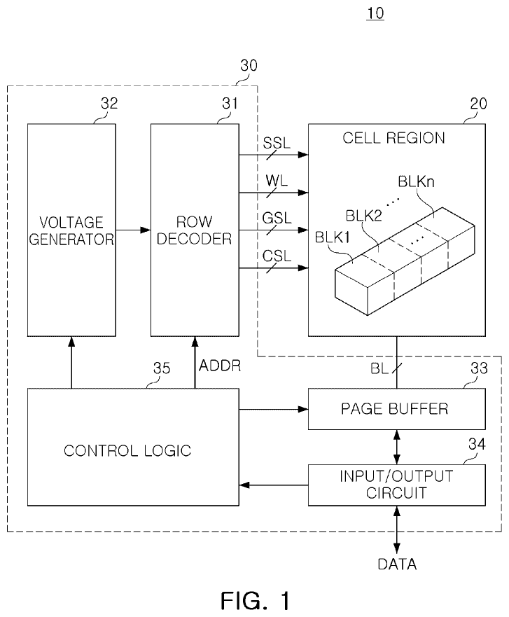

FIG. 1 is a drawing illustrating an example of a memory device according to some example embodiments.

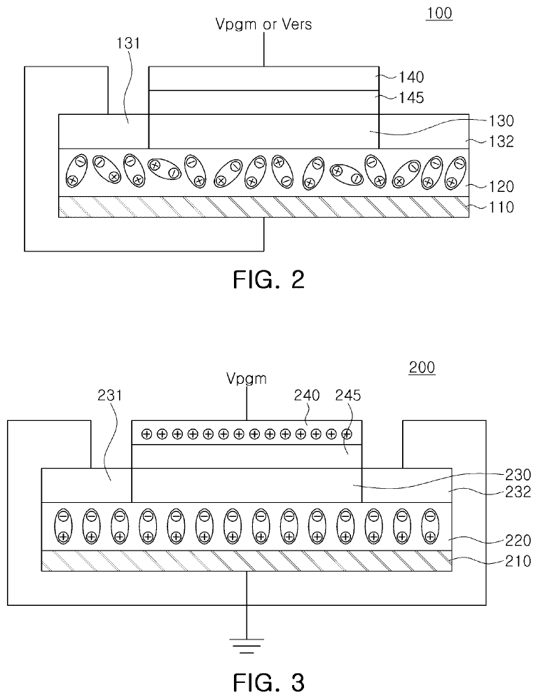

FIG. 2 is a drawing illustrating an example of a memory cell according to some example embodiments.

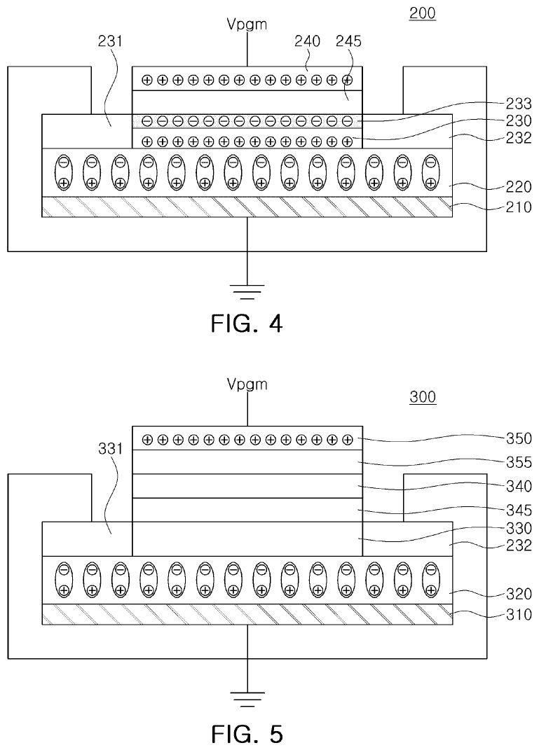

FIGS. 3 and 4 are drawings provided to illustrate the operation of a memory cell according to some example embodiments.

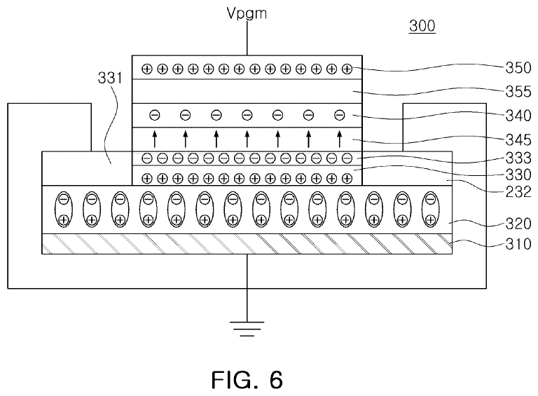

FIGS. 5 and 6 are drawings provided to illustrate the operation of a memory cell according to some example embodiments.

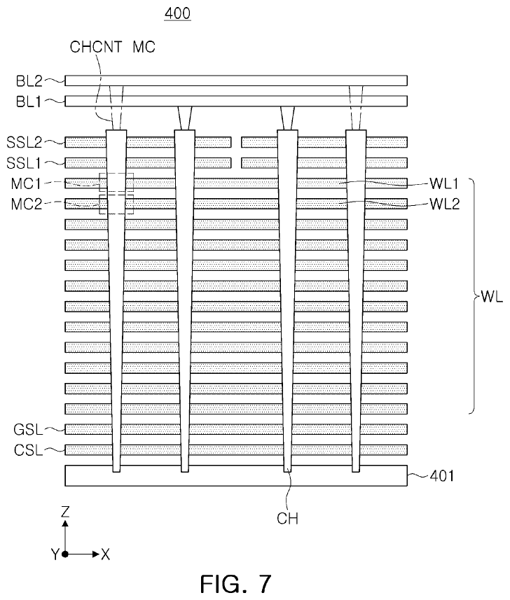

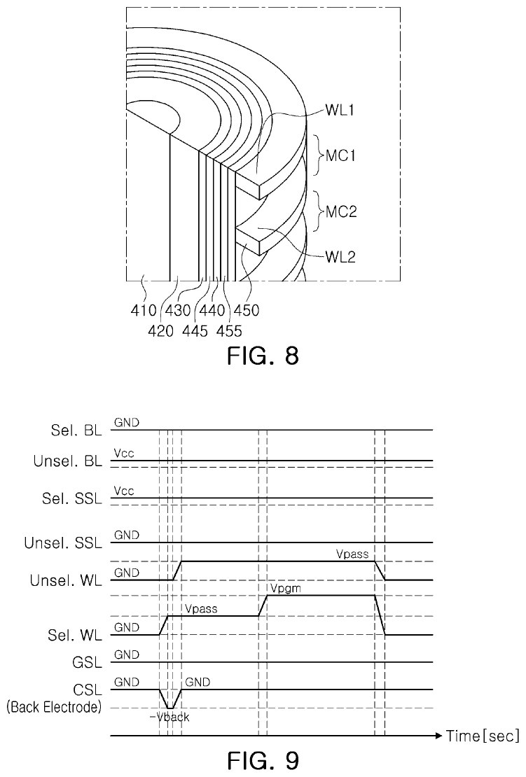

FIGS. 7 and 8 are drawings schematically illustrating an example of a memory device according to some example embodiments.

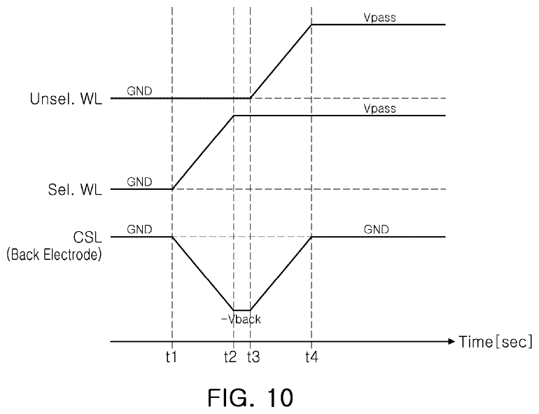

FIGS. 9 and 10 are drawings provided to illustrate the operation of a memory device according to some example embodiments.

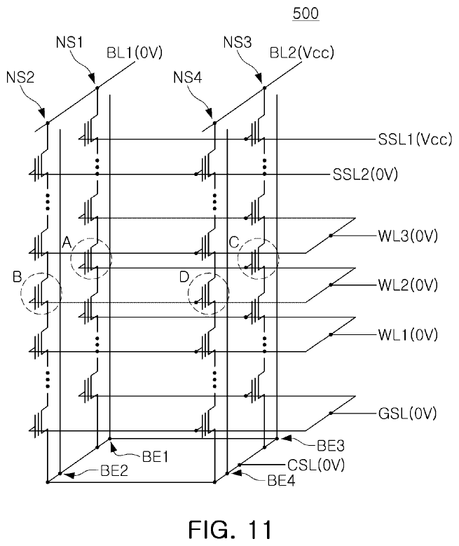

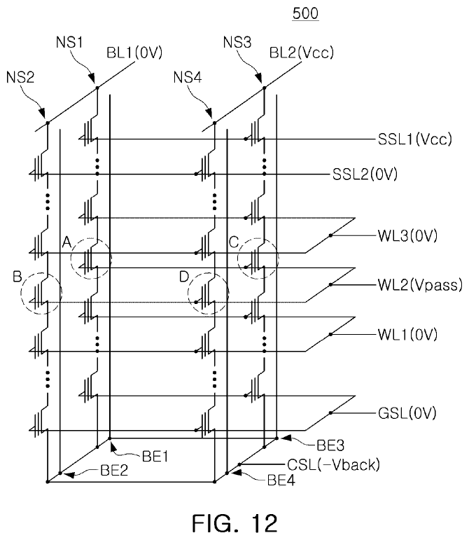

FIGS. 11 to 13 are drawings provided to illustrate the operation of a memory device according to some example embodiments.

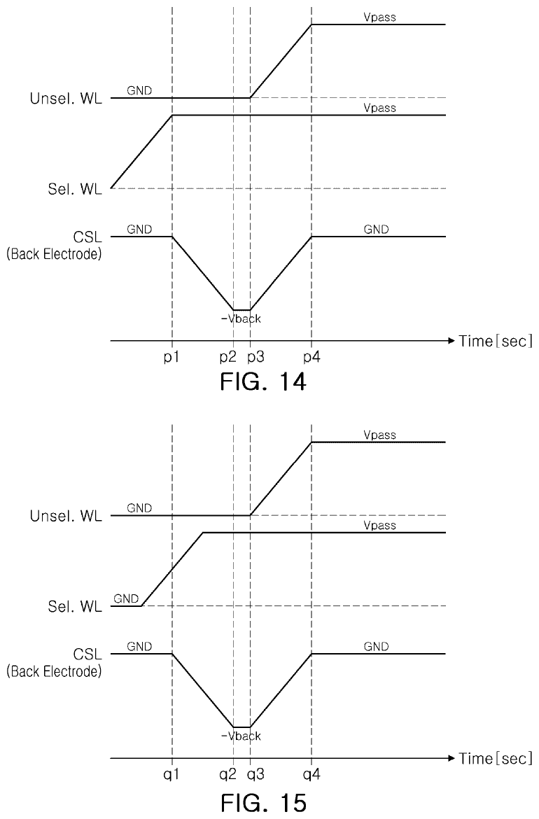

FIGS. 14 to 17 are drawings provided to illustrate the operation of a memory device according to some example embodiments.

### DETAILED DESCRIPTION

Hereinafter, example embodiments will be explained in detail with reference to the accompanying diagrams.

FIG. 1 is a drawing illustrating an example of a memory device according to some example embodiments.

Referring to FIG. 1, a memory device 10 may include a cell region 20 and a peripheral circuit region 30. The peripheral circuit region 30 may include a row decoder 31, a voltage generator 32, a page buffer 33, an input/output circuit 34, and a control logic 35.

The cell region 20 includes a plurality of memory cells, and may be divided into a plurality of blocks (BLK1 to BLKn). The plurality of blocks (BLK1 to BLKn) may be connected to a row decoder 31 through common source lines CSL, string selection lines (SSL), word lines (WL), and ground selection line (GSL), and may be connected to a page buffer 33 through bit lines BL. For example, in each of the blocks (BLK1 to BLKn), the plurality of memory cells arranged at the same distance from a substrate may be connected to the same word line (WL), and the plurality of memory cells disposed in the same position on a plane parallel to an upper surface of the substrate may provide a memory cell string sharing one channel layer. For example, in each of the blocks (BLK1 to BLKn), a plurality of memory cells arranged at the same distance from a substrate may be connected to the same word line (WL), and the plurality of memory cells disposed in the same position on a plane parallel to an upper surface of the substrate may provide a memory cell string sharing one channel layer.

The row decoder 31 may decode address data (ADDR) input from the control logic 35, or the like, and generate and transmit voltages for driving the word line (WL). The row decoder 31 may input a word line voltage generated by the voltage generator 32 to the word lines (WL) in response to the control of the control logic 35. For example, the row decoder 31 may be connected to the word lines (WL) through pass transistors, and may input a word line voltage to the word lines (WL) when the pass transistors are turned on.

The page buffer 33 may be connected to the cell region 20 through bit lines (BL), and may read data stored in memory cells, or write data to memory cells. The page buffer 33 may include a column decoder, a latch circuit, or the like. The column decoder may select at least a portion of the bit lines (BL) of the cell region 20, and the latch circuit may read data of a memory cell connected to the bit lines (BL) selected by the column decoder during a read operation.

The input/output circuit 34 may receive data (DATA) during a program operation and transmit the data to the page buffer 33, and during a read operation, the page buffer 33 may output data (DATA) read from the cell region 20 externally. The input/output circuit 34 may transmit an address or command received from an external memory controller to the control logic 35.

The control logic 35 may control the operation of the row decoder 31, voltage generator 32, page buffer 33, and input/output circuit 34. In an example embodiment, the control logic 35 may operate according to a control command transmitted from an external memory controller, or the like.

The voltage generator 32 may generate control voltages required for the operation of the memory device 10, such as a program voltage, a read voltage, an erase voltage, a pass voltage, or the like, by using a power voltage input from the outside. The voltage generated by the voltage generator 32 may be supplied to the peripheral circuit region 30 or input to the cell region 20 through a row decoder 31, or the like.

The peripheral circuit region 30 may execute program operations, read operations, erase operations, or the like, for a plurality of blocks (BLK1 to BLKn), and the program operation may be executed for each of a plurality of memory cells as a unit. For example, the peripheral circuit region 30 may input a ground voltage to a common source line CSL and/or bit lines (BL) connected to at least one selected memory cell from among a plurality of memory cells on which a program operation is to be performed, and input a program voltage to a selected word line connected to at least one selected memory cell to perform a program operation.

In a program operation, a pass voltage may be input to a selected word line connected to at least one selected memory cell and unselected word lines, different from the selected word line. In an example embodiment of the present inventive concept, a plurality of blocks (BLK1 to BLKn) may further include a common source line CSL connected to a back electrode layer, and a back bias voltage may be input to the common source line CSL before the pass voltage is input to the unselected word lines. For example, while inputting a pass voltage to a selected word line, a back bias voltage may be input to the back electrode layer through a common source line CSL, and after a ground voltage is input to the back electrode layer through the common source line CSL, the pass voltage may be input to unselected word lines.

The memory device 10 according to an example embodiment of the present inventive concept may include a plurality of word lines (WL) stacked in a first direction (Z-axis direction) perpendicular to an upper surface of a substrate, and a plurality of channel structures extending in the first direction and penetrating through the plurality of word lines (WL). Each of the plurality of channel structures may include a lower electrode layer and a channel layer connected to the substrate, a ferroelectric layer disposed between the lower electrode layer and the channel layer, a gate electrode layer, at least one oxide layer disposed between the channel layer and the gate electrode layer, a drain region disposed above the channel layer, or the like. In a memory device according to an example embodiment of the present inventive concept, the back electrode layer may be electrically connected to a common source line CSL.

At least one oxide layer may include a tunneling layer, a charge trap layer, a blocking layer, or the like. For example, the tunneling layer, the charge trap layer, and the blocking layer may be sequentially disposed between the channel layer and the word line. The drain region may be connected to at least one of the bit lines (BL) through a bit line contact, and the bit line (BL) may be connected to a page buffer 33 included in the peripheral circuit region 30. The bit lines (BL) may extend in a direction parallel to the upper surface of the substrate.

Meanwhile, the memory device 10 according to an example embodiment of the present inventive concept may include a plurality of channel structures including a lower electrode layer electrically connected to a common source line CSL and a ferroelectric layer disposed between the lower electrode layer and the channel layer. In a program operation for a selected memory cell, before a pass voltage is input to unselected word lines not connected to the selected memory cell, a pass voltage may be input to a selected word line connected to the selected memory cell and a back bias voltage may be input to a back electrode layer through a common source line CSL. Due to a difference between the pass voltage input to the selected word line and the back bias voltage input to the back electrode layer, a polarization direction of the ferroelectric layer may be inverted before an inversion layer is formed in the channel layer of the selected memory cell. Therefore, the memory device 10 having improved performance of the program operation may be provided.

FIG. 2 is a drawing illustrating an example of a memory cell according to some example embodiments.

Referring to FIG. 2, a memory cell 100 may include a channel layer 130 including a semiconductor material, a source region 131 and a drain region 132 disposed on both sides of the channel layer 130, and a gate insulating layer 145 and a gate electrode layer 140 sequentially disposed on the channel layer 130. In addition, the memory cell 100 according to an example embodiment of the present inventive concept may include a ferroelectric layer 120 and a back electrode layer 110 disposed below the channel layer 130. The program operation and erase operation for the memory cell 100 may be performed in a manner of switching a polarization direction of the ferroelectric layer 120.

The ferroelectric layer 120 may include a ferroelectric material. The memory cell 100 may invert a dipole polarization direction of the ferroelectric layer 120 by a voltage input to the gate electrode layer 140 and the back electrode layer 110. By inverting the dipole polarization direction of the ferroelectric layer 120, data may be written to or erased from the memory cell 100 by changing a threshold voltage of the memory cell 100. For example, when a positive voltage is input to the gate electrode layer 140 and a ground voltage is input to the back electrode layer 110, the polarization direction of the ferroelectric layer 120 may be inverted. By inverting the polarization direction of the ferroelectric layer 120, the same effect as when a negative voltage is input to the ferroelectric layer 120 may occur, and the threshold voltage of the memory cell 100 may increase.

By using a ferroelectric layer 120 including a ferroelectric material, a memory device may operate with a relatively small operating voltage, and may implement a fast operating speed. The memory cell 100 may write or erase data by using the polarization change of the ferroelectric layer 120 caused by a voltage input to the gate electrode layer 140. Referring to FIGS. 3 and 4, an operation of writing or erasing data by changing the threshold voltage of the memory cell 100 will be described in detail hereinafter.

FIGS. 3 and 4 are drawings provided to illustrate the operation of a memory cell according to some example embodiments.

Referring to FIGS. 3 and 4, a memory cell 200 may include a channel layer 230 including a semiconductor material, a source region 231 and a drain region 232 disposed on both sides of the channel layer 230, and a gate insulating layer 245 and a gate electrode layer 240 sequentially disposed on the channel layer 230. In addition, the memory cell 200 according to an example embodiment of the present inventive concept may include a ferroelectric layer 220 and a back electrode layer 210 disposed below the channel layer 230. The program operation and erase operation for the memory cell 200 may be performed in a manner of switching the polarization direction of the ferroelectric layer 220.

Referring to FIG. 3, in a program operation for the selected memory cell 200, a program voltage Vpgm may be input to a gate electrode layer 240 of the selected memory cell 200, and a ground voltage may be input to a source region 231, a back electrode layer 210 connected to the source region 231, and a drain region 232. When a program voltage Vpgm is input to the gate electrode layer 240, the polarization direction of the ferroelectric layer 220 may be switched. For example, the ferroelectric layer 120 may generate the same effect as when a negative voltage is input. Therefore, a current does not easily flow between the gate electrode layer 240 and the back electrode layer 210, and a threshold voltage of the memory cell 200 may increase. By changing the threshold voltage of the memory cell 200 by inputting a voltage to the gate electrode layer 240, data can be written or erased.

Referring to FIG. 4, as the polarization direction of the ferroelectric layer 220 of the selected memory cell 200 is inverted, charges in the channel layer 230 may be concentrated in a region relatively close to the gate electrode layer 240. Accordingly, an inversion layer 233 may be formed on an upper surface of the channel layer 230, and the inversion layer 233 may minimize the inversion of the polarization direction of the ferroelectric layer 220 by a voltage input to the gate electrode layer 240 after the program operation.

Meanwhile, in a program operation for a selected memory cell 200, a pass voltage may be input before the program voltage Vpgm is input to the gate electrode layer 240 of the selected memory cell 200. In an example embodiment, the pass voltage may be a voltage sufficient to move charges in the channel layer 230 to form an inversion layer 233, but less than a voltage to invert a polarization direction of the ferroelectric layer 220. When the pass voltage is input to the gate electrode layer 240 of the selected memory cell 200, an inversion layer 233 may be formed in the channel layer 230 before the polarization direction of the ferroelectric layer 220 is inverted. Accordingly, even if the program voltage Vpgm is input to the gate electrode layer 240 of the selected memory cell 200 thereafter, a problem in which the polarization direction of the ferroelectric layer 220 may not be inverted by the inversion layer 233 may occur.

In a program operation for a selected memory cell 200, before inputting a pass voltage to unselected word lines, different from a selected word line, a memory device according to an example embodiment of the present inventive concept may input a pass voltage to the selected word line and input a back bias voltage to the back electrode layer 210, thereby inverting a polarization direction of the ferroelectric layer 220 before an inversion layer 233 is formed in a channel layer 230. Accordingly, a threshold voltage of the selected memory cell 200 may be increased, and data can be written to the selected memory cell 200.

FIGS. 5 and 6 are drawings provided to illustrate the operation of a memory cell according to some example embodiments.

Referring to FIGS. 5 and 6, a memory cell 300 according to an example embodiment of the present inventive concept may include a back electrode layer 310, a channel layer 330, and a gate electrode layer 350 extending in a first direction perpendicular to a substrate and sequentially disposed in a direction parallel to an upper surface of the substrate. A ferroelectric layer 320 may be disposed between the back electrode layer 310 and the channel layer 330, and the ferroelectric layer 320 may include a ferroelectric material.

In an example embodiment, the memory cell 300 may extend in a first direction and be disposed between the channel layer 330 and the gate electrode layer 350 in a direction parallel to the upper surface of the substrate, and may include at least one charge trap layer 340 trapping charges for storing data. At least one first oxide layer 355 may be included between at least one charge trap layer 340 and the gate electrode layer 350, and at least one second oxide layer 345 may be included between at least one charge trap layer 340 and the channel layer 330. In an example embodiment, the first oxide layer 355 may be a blocking layer, and the second oxide layer 345 may be a tunneling layer. For example, charges may be transferred between the charge trap layer 340 and the channel layer 330 through the second oxide layer 345.

Referring to FIG. 5, during a program operation, a program voltage Vpgm may be input to a selected gate electrode layer 350 of a selected memory cell 300, a ground voltage may be input to a source region 331 and a back electrode layer 310 connected to the source region 331, and a ground voltage may be input to a drain region 332. When a program voltage Vpgm is input to the gate electrode layer 350, a polarization direction of the ferroelectric layer 320 may be inverted. For example, the ferroelectric layer 320 may have the same effect as when a negative voltage is input. Therefore, current does not easily flow between the gate electrode layer 350 and the back electrode layer 310, and a threshold voltage of the memory cell 300 may increase. Data may be written or erased by changing the threshold voltage of the memory cell 300 by inputting a voltage to the gate electrode layer 350.

Referring to FIG. 6, as a polarization direction of the ferroelectric layer 320 of the memory cell 300 is inverted, charges in the channel layer 330 may be concentrated in a region relatively close to the gate electrode layer 350. Accordingly, an inversion layer 333 may be formed on an upper surface of the channel layer 330, and the inversion layer may minimize switching of the polarization direction of the ferroelectric layer 320 by the voltage input to the gate electrode layer 350.

A portion of charges in the channel layer 330 may move to a charge trap layer 340 through the second oxide layer 345, and the charges may be trapped in a charge trap layer 340. Due to a polarization direction of the ferroelectric layer 320, charges in the channel layer 330 may move to the charge trap layer 340 close to the gate electrode layer 350 through the second oxide layer 345. Charges having moved to the charge trap layer 340 may be trapped in the charge trap layer 340 instead of moving to the gate electrode layer 350 due to the first oxide layer 355.

In a program operation for a selected memory cell 300, a memory device according to an example embodiment of the present inventive concept may input a pass voltage to a gate electrode layer 350 of a selected memory cell 300 and input a back bias voltage to a back electrode layer 310 before inputting a pass voltage to unselected word lines, different from a selected word line, thereby first inverting the polarization direction of a ferroelectric layer 320 before an inversion layer 333 is formed in a channel layer 330, thereby providing a memory device having improved performance of a program operation.

FIGS. 7 and 8 are drawings schematically illustrating an example of a memory device according to some example embodiments.

Referring to FIG. 7, a memory device 400 may include a plurality of word lines WL stacked on a substrate 401, a plurality of string selection lines SSL1 and SSL2 disposed above the plurality of word lines WL, a ground selection line GSL disposed between the plurality of word lines WL and the substrate 401, a common source line CSL, and the like. In an example embodiment illustrated in FIG. 7, it is illustrated that the first string selection line SSL1 and the second string selection line SSL2 are stacked in a first direction (Z-axis direction), but the number of plurality of string selection lines SSL1 and SSL2 may vary depending on the example embodiment.

A plurality of channel structures CH may extend in a first direction and be connected to the substrate 401 by penetrating through a plurality of word lines WL, a plurality of string selection lines SSL1 and SSL2, a ground selection line GSL, and a common source line CSL, and may be connected to bit lines BL1 and BL2 through upper channel contacts CHCNT.

The plurality of word lines WL may provide memory cells together with the plurality of channel structures CH. The number of memory cells may be determined according to the number of the plurality of word lines WL and the number of the plurality of channel structures CH.

Referring to FIGS. 7 and 8, each of a plurality of channel structures CH according to an example embodiment of the present inventive concept may extend in a first direction (Z-axis direction) perpendicular to the semiconductor substrate, and a back electrode layer 410 and a channel layer 430 may be disposed below a plurality of word lines WL. The back electrode layer 410 and the channel layer 430 may be connected to a source region of the substrate. A ferroelectric layer 420 may be disposed between the back electrode layer 410 and the channel layer 430, and a tunneling layer 445, a charge trap layer 440, and a blocking layer 455 may be included between the channel layer 430 and the word line 450.

The first memory cell MC1 and the second memory cell MC2 may be connected to the same second bit line BL2 through one channel structure, but may be connected to different word lines WL1 and WL2. Referring to FIGS. 7 and 8 together, in a direction parallel to an upper surface of the substrate 401, a portion connected to the first word line WL1 may be a first memory cell MC1, and a portion connected to the second word line WL2 may be a second memory cell MC2.

For example, the first memory cell MC1 may be a selected memory cell, and the second memory cell MC2 may be an unselected memory cell. To program the first memory cell MC1, a ground voltage may be input to a second bit line to which the first memory cell MC1 and the second memory cell MC2 are connected together, a program voltage may be input to the first word line WL1, and a pass voltage may be input to the second word line WL2.

Meanwhile, in a program operation for the first memory cell MC1, a pass voltage may be input before a program voltage is input to the first word line WL1. When a pass voltage is input to the first word line WL1, an inversion layer is first formed in the channel layer 430 before a polarization direction of the ferroelectric layer 420 is inverted, so that even if a program voltage is input to the first word line WL1, a problem in which the polarization direction of the ferroelectric layer 420 may not be inverted due to the inversion layer may occur.

In a program operation for a first memory cell MC1, before inputting a pass voltage to unselected word lines WL2, the memory device according to an example embodiment of the present inventive concept may input a pass voltage to the first word line WL1 and a back bias voltage to the back electrode layer 410, thereby first inverting a polarization direction of the ferroelectric layer 420 before an inversion layer is formed in the channel layer 430. Accordingly, a threshold voltage of the first memory cell MC1 may be increased, and data may be written to the first memory cell MC1. Hereinafter, the operation of the memory device will be described in detail with reference to FIGS. 9 to 13.

FIGS. 9 and 10 drawings provided to illustrate the operation of a memory device according to some example embodiments.

A program operation for a selected memory cell may be performed by an Incremental Step Pulse Program (ISPP) operation. The ISPP operation includes N program loops, where N is a natural number, and each program loop may include a program operation and a program verification operation. In an example embodiment, FIG. 9 may be a drawing illustrating only a program operation excluding a program verification operation (not shown) of the first program loop in the ISPP operation process.

Referring to FIG. 9, a peripheral circuit region of the memory device according to an example embodiment of the present inventive concept may input a program voltage by selecting one selected word line Sel.WL of a plurality of word lines. The selected word line Sel.WL may be a word line connected to a selected memory cell to be programmed.

As illustrated in FIG. 9, before inputting a program voltage Vpgm to a selected word line Sel.WL, a peripheral circuit region may input a pass voltage Vpass to the selected word line Sel.WL and an unselected word line Unsel.WL. Before inputting a pass voltage Vpass to the unselected word line Unsel.WL, the peripheral circuit region may input a pass voltage Vpass to the selected word line Sel.WL, and input a back bias voltage −Vback to a common source line CSL connected to the back electrode layer. Before inputting a pass voltage Vpass to the unselected word line Unsel.WL, the peripheral circuit region may input a pass voltage Vpass to the selected word line Sel.WL, and input a back bias voltage −Vback to a common source line CSL connected to the back electrode layer.

While a pass voltage Vpass is input to the selected word line Sel.WL and the unselected word line Unsel.WL, the peripheral circuit region may input a ground voltage GND to a selected bit line Sel.BL connected to the NAND string including the selected memory cell. Meanwhile, a power supply voltage Vcc can be input to an unselected bit line Unsel.BL connected to the NAND string not including the selected memory cell. In addition, the peripheral circuit region may input a power voltage Vcc to a selected string line Sel.SSL connected to the selected string line. Meanwhile, a ground voltage may be input to an unselected string line Unsel.SSL connected to a NAND string different from the selected string line. The peripheral circuit region may input a ground voltage GND to a ground selected line GSL during the program operation.

Referring to FIG. 9, a peripheral circuit region of a memory device according to an example embodiment of the present inventive concept may input a pass voltage Vpass to a selected word line Sel.WL and an unselected word line Unsel.WL, and input a ground voltage GND to a common source line CSL connected to a back electrode layer. Thereafter, the peripheral circuit region may maintain a voltage of the unselected word line Unsel WL at the pass voltage Vpass, maintain a voltage of the common source line CSL at the ground voltage GND, and input a program voltage Vpgm to the selected word line Sel.WL. For example, a falling point in time of the program voltage Vpgm input to the selected word line Sel.WL and a falling point in time of the pass voltage Vpass input to the unselected word line Unsel.WL may coincide.

In an example embodiment, a difference between a pass voltage Vpass and a back bias voltage-Vback may be greater than or equal to the program voltage Vpgm. Alternatively, the difference between the pass voltage Vpass and the back bias voltage-Vback may be greater than or equal to a voltage inverting a polarization direction of a ferroelectric layer. The program voltage Vpgm may be greater than the voltage inverting the polarization direction of the ferroelectric layer. For example, the pass voltage Vpass may be less than the voltage inverting the polarization direction of the ferroelectric layer.

A program operation for the selected memory cell may be performed by an Incremental Step Pulse Program (ISPP) operation. The ISPP operation consists of N program loops, where N is a natural number, and each program loop may include a program operation and a program verification operation. The program loop may be performed repeatedly while increasing a program voltage Vpgm until the program voltage Vpgm reaches a threshold voltage. For example, if the program voltage Vpgm of a first program loop is 13 V, an increasing voltage is 0.3 V, and the program loop is performed 20 times, the program voltage Vpgm may increase by 0.3 V each time the program loop is performed, and may increase to 13.3 V, 13.6 V, ..., 18.7 V.

In a memory device according to an example embodiment of the present inventive concept, at least one program loop among N program loops may include a program operation of inputting a pass voltage Vpass to a selected word line Sel. WL and inputting a back bias voltage-Vback to a common source line CSL connected to a back electrode layer. Referring to FIG. 9, a first program loop may include a program operation of inputting a pass voltage Vpass to a selected word line Sel.WL and inputting a back bias voltage −Vback to a common source line CSL. In an example embodiment, at least one program loop from a second program loop to a N^{th} program loop may include a program operation of inputting a pass voltage Vpass to a selected word line Sel.WL and inputting a back bias voltage −Vback to a common source line CSL. Among the N^{th} program loops, the program loop including the program operation may be performed at least once and at most N times, including the first program loop. For example, the first program loop and the M^{th}, where M is a natural number greater than or equal to 2 and less than or equal to N, program loop may include the program operation.

Referring to FIG. 10, a peripheral circuit region of a memory device according to an example embodiment of the present inventive concept may input a pass voltage Vpass to a selected word line Sel.WL and input a back bias voltage −Vback to a common source line CSL.

In a program operation for a selected memory cell connected to at least one selected word line Sel.WL among a plurality of word lines, the peripheral circuit region may input a pass voltage Vpass to the selected word line Sel.WL and input a back bias voltage −Vback to the common source line CSL connected to the back electrode layer from a first point in time t1. The peripheral circuit region may maintain a voltage of the common source line CSL connected to the back electrode layer at the back bias voltage −Vback during a period from a second point in time t2 to a third point in time t3 after the first point in time t1, and input a pass voltage Vpass to the unselected word line Unsel. WL after the third point in time t3.

Referring to FIG. 10, a polarization direction of the ferroelectric layer included in the selected memory cell may be inverted during the period from the second point in time t2 to the third point in time t3. For example, the period from the second point in time t2 to the third point in time t3 may be 10 ns or more and 100 ns or less, but an example embodiment thereof is not limited thereto, and a minimum period may vary for each memory device depending on the thickness of the ferroelectric layer included in the selected memory cell, or the like. The period from the second point in time t2 to the third point in time t3 may be shorter than the time for forming an inversion layer in the channel layer of the selected memory cell. From the third point in time t3, a difference between the voltage of the unselected word line Unsel.WL and the voltage of the common source line CSL connected to the back electrode layer may be equal to or less than the pass voltage Vpass.

From a fourth point in time t4 after the third point in time t3, an inversion layer may be formed in the channel layer of the selected memory cell. Since the inversion layer may minimize the influence of an external electric field on the ferroelectric layer, the inversion layer may effectively prevent data from being deformed or damaged after the polarization direction of the ferroelectric layer of the selected memory cell is inverted. From the fourth point in time t4, a ground voltage GND may be provided to the common source line CSL connected to the back electrode layer.

Before inputting a program voltage Vpgm to a selected word line Sel.WL during a program operation, a peripheral circuit region of a memory device according to an example embodiment of the present inventive concept may input a pass voltage Vpass to a selected word line Sel.WL and unselected word lines Unsel.WL. Before the pass voltage Vpass is input to the unselected word lines Unsel.WL, a pass voltage Vpass may be input to a selected word line Sel.WL connected to a selected memory cell, a back bias voltage −Vback may be input to a back electrode layer through a common source line CSL, and a polarization direction of a ferroelectric layer may be first inverted before an inversion layer is formed in the selected memory cell, thereby improving the program operation performance of the memory device.

FIGS. 11 to 13 are drawings provided to illustrate the operation of a memory device according to some example embodiments.

Referring to FIGS. 11 to 13, a memory device 500 may include a plurality of NAND strings NS1 to NS4. The plurality of NAND strings NS1 to NS4 may be included in one block, and thus may share word lines WL1 to WL3. The first and second NAND strings NS1 and NS2 may be commonly connected to a first bit line BL1, and the third and fourth NAND strings NS3 and NS4 may be commonly connected to a second bit line BL2.

In addition, the first and third NAND strings NS1 and NS3 may be commonly connected to a first string selection line SSL1, and the second and fourth NAND strings NS2 and NS4 may be commonly connected to a second string selection line SSL2. The plurality of NAND strings NS1 to NS4 may share one ground selection line GSL and one common source line CSL. A plurality of back electrodes BE1 to BE4 may be connected to the common source line CSL.

In an example embodiment described with reference to FIGS. 11 to 13, a selected memory cell A may be included in a first NAND string NS1 and may be connected to a second word line WL2.

First, FIG. 11 may be a diagram illustrating voltages input to the plurality of NAND strings NS1 to NS4. Referring to FIG. 11, a ground voltage may be input to a first bit line BL1, a selected bit line, and a power supply voltage Vcc, higher than the ground voltage may be input to a second bit line BL2, an unselected bit line. Meanwhile, a power supply voltage Vcc may be input to the first string selected line SSL1 connected to the first NAND string NS1, and a ground voltage may be input to the second string selected line SSL2. A ground voltage may be input to the word lines WL1 to WL3. A ground voltage may also be input to the ground selected line GSL and the common source line CSL.

As described above with reference to FIGS. 9 and 10, when a write operation starts, a pass voltage Vpass may be input first before a program voltage is input to a selected word line connected to a selected memory cell A. A pass voltage Vpass may be input to the second word line WL2, a selected word line, and a back bias voltage-Vback may be input to a plurality of rear electrodes BEL1 to BEL4 through a common source line CSL. A difference between the pass voltage Vpass and the back bias voltage-Vback may be greater than or equal to a voltage inverting a polarization direction of the ferroelectric layer of the selected memory cell A. Therefore, the polarization direction of the ferroelectric layer of the selected memory cell A can be inverted. On the other hand, a pass voltage may not be input to the unselected word lines WL1 and WL3 connected to the unselected memory cells B, C, D, and therefore, the polarization direction of the ferroelectric layer of the unselected memory cells B, C, D may be maintained without being inverted.

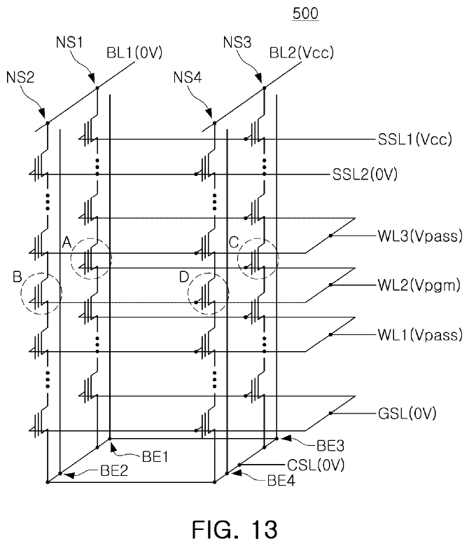

FIG. 13 may be a diagram illustrating that, in a program operation for a selected memory cell A, a pass voltage Vpass is input to unselected word lines WL1 and WL3 of which peripheral circuit regions are not connected to the selected memory cell A. Before the pass voltage Vpass is input to the unselected word lines WL1 and WL3, a ground voltage may be input first to a common source line CSL. After the pass voltage Vpass is input to both the selected word line WL2 and the unselected word lines WL1 and WL3, a program voltage Vpgm may be input to the selected word line WL2.

FIGS. 11 to 13 may be diagrams illustrating voltages input to a plurality of NAND strings NS1 to NS4 before a program voltage is input to a selected word line as described above with reference to FIGS. 9 and 10. A ground voltage, power supply voltage Vcc, pass voltage Vpass, and back bias voltage −Vback may be input to the plurality of NAND strings NS1 to NS4. As described with reference to FIGS. 9 and 10, before a pass voltage Vpass is input to the unselected word lines, a pass voltage Vpass may be input to the selected word lines and a back bias voltage-Vback may be input to the back electrode layer.

In an example embodiment of the present inventive concept, before a program voltage is input to a selected word line to invert a polarization direction of a ferroelectric layer of a selected memory cell A, to prevent the problem in which a pass voltage Vpass is input to the selected word line so that an inversion layer is formed first in the channel layer from occurring, a pass voltage Vpass may be input to the selected word line, and a back bias voltage −Vback may be input to the common source line CSL connected to the back electrode layer.

As described above, by inputting a pass voltage Vpass to the selected word line before the pass voltage Vpass is input to the unselected word line, and inputting a back bias voltage −Vback to a common source line CSL connected to the back electrode layer, a polarization direction of the ferroelectric may be first inverted before the inversion layer is formed in the channel layer of the selected memory cell A. In addition, by inputting a pass voltage Vpass to the unselected word line after a ground voltage is input to the common source line CSL, the polarization direction of the ferroelectric layer of the unselected memory cells B, C, and D may be maintained without being inverted. Therefore, the program operation performance of the memory device may be improved.

FIGS. 14 to 17 drawings provided to illustrate the operation of a memory device according to some example embodiments.

Referring to FIG. 14, a peripheral circuit region of a memory device according to an example embodiment of the present inventive concept may input a pass voltage Vpass to a selected word line Sel.WL and input a back bias voltage −Vback to a common source line CSL.

In a program operation for a selected memory cell connected to at least one selected word line Sel.WL among a plurality of word lines, before inputting a pass voltage Vpass to unselected word lines Unsel. WL different from the selected word line Sel.WL, the peripheral circuit region may input a back bias voltage −Vback, lower than a ground voltage GND to a common source line CSL connected to the back electrode layer, and set a difference between voltages of the unselected word lines Unsel.WL and a voltage of the common source line CSL connected to the back electrode layer to be less than or equal to the pass voltage Vpass. For example, the pass voltage Vpass may be half the program voltage, and an absolute value of the pass voltage Vpass and an absolute value of the back bias voltage −Vback can be the same.

Referring to FIG. 14, a peripheral circuit region of a memory cell according to an example embodiment of the present inventive concept may input a pass voltage Vpass to a selected word line Sel.WL before a first point in time p1, and may input a back bias voltage-Vback to a common source line CSL connected to a back electrode layer from the first point in time p1. In an example embodiment, a positive voltage may start to be input to the selected word line Sel. WL before a negative voltage is input to the common source line CSL connected to the back electrode layer. For example, the voltage of the selected word line Sel.WL at the first point in time p1 may be a pass voltage Vpass.

During a period from a second point in time p2 to a third point in time p3 after the first point in time p1, a voltage of the common source line CSL connected to the back electrode layer may be maintained at a back bias voltage −Vback, and from the third point in time p3, the peripheral circuit region may input a ground voltage GND to the common source line CSL, and input a pass voltage Vpass to the unselected word line Unsel.WL. For example, a transition time of the pass voltage Vpass input to the selected word line Sel.WL and a transition time of the back bias voltage −Vback input to the common source line CSL connected to the back electrode layer may be the same.

Referring to FIG. 15, a peripheral circuit region of a memory cell according to an example embodiment of the present inventive concept may input a pass voltage Vpass to a selected word line Sel.WL before a first point in time q1, and may input a back bias voltage-Vback to a common source line CSL connected to a back electrode layer from the first point in time q1. In an example embodiment, after a negative voltage is input to the common source line CSL connected to the back electrode layer, a positive voltage may start to be input to the selected word line Sel.WL. For example, a voltage of the selected word line Sel.WL at the first point in time q1 may be less than the pass voltage Vpass.

In a program operation for a selected memory cell connected to at least one selected word line Sel.WL among a plurality of word lines, a peripheral circuit region of a memory device according to an example embodiment of the present inventive concept, while a ground voltage GND is input to unselected word lines Unsel.WL different from the selected word line Sel.WL, may input a positive voltage to the selected word line Sel.WL and a negative voltage to the common source line CSL connected to the back electrode layer. A difference between the positive and negative voltages may be greater than a voltage required to invert the polarization direction of the ferroelectric layer of the selected memory cell. For example, a peripheral circuit region included in a memory device according to an example embodiment of the present inventive concept may start inputting a negative voltage to a back electrode layer after starting to input a positive voltage to a selected word line Sel.WL.

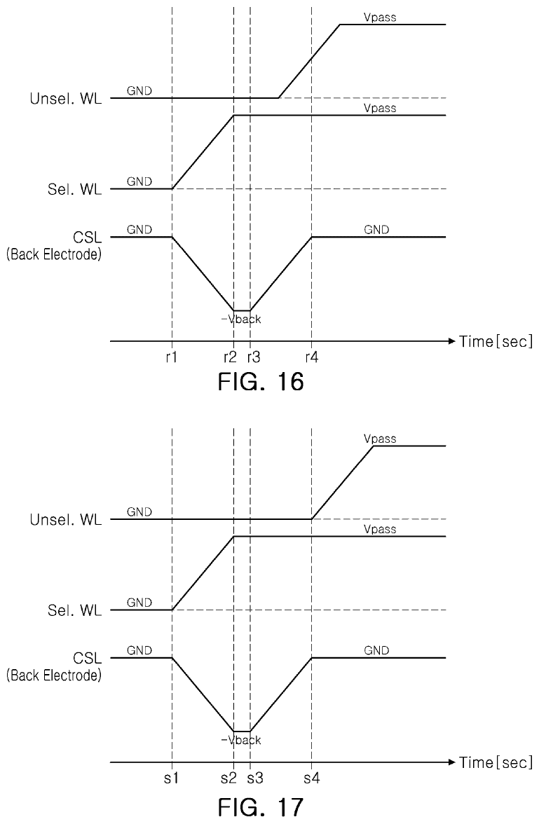

A peripheral circuit region of a memory device according to an example embodiment of the present inventive concept may input a pass voltage Vpass to unselected word lines Unsel.WL, before the voltage of the back electrode layer of a selected memory cell becomes a ground voltage. Referring to FIG. 16, the peripheral circuit area may input a ground voltage GND to the common source line CSL connected to the back electrode layer from a third point in time r3, and may input a pass voltage Vpass to the unselected word lines Unsel.WL between the third point in time r3 and the fourth point in time r4.

After the voltage of the back electrode layer of the selected memory cell becomes a ground voltage, a peripheral circuit region of a memory device according to an example embodiment of the present inventive concept may input a pass voltage Vpass to unselected word lines Unsel.WL. Referring to FIG. 17, the peripheral circuit region may input a ground voltage GND to the common source line CSL connected to the back electrode layer from the third point in time s3, and from a fourth point in time s4 after the third time point s3, the voltage of the common source line CSL may be a ground voltage GND, and a pass voltage Vpass may be input to the unselected word lines Unsel.WL.

As set forth above, according to an example embodiment of the present inventive concept, in a program operation for a selected memory cell, a peripheral circuit region of a memory device may input a pass voltage to a selected word line connected to the selected memory cell, and a back bias voltage to a back electrode layer, thereby inverting a polarization direction of a ferroelectric layer before an inversion layer is formed in a channel layer of the selected memory cell. By first inverting the polarization direction of the ferroelectric layer before an inversion layer is formed in a channel layer of the selected memory cell connected to the selected word line, a memory device having improved performance of a program operation can be provided.

The various advantages and effects of the present inventive concept are not limited to the above-described content, and can be more easily understood through description of specific embodiments of the present inventive concept.

While example embodiments have been illustrated and described above, it will be apparent to those skilled in the art that modifications and variations could be made without departing from the scope of the present inventive concept as defined by the appended claims.

What is claimed is:

1. A memory device, comprising:
a cell region including a plurality of word lines stacked on a substrate, and a plurality of channel structures extending in a first direction, perpendicular to the substrate and penetrating through the plurality of word lines; and
a peripheral circuit region including peripheral circuits configured to control the cell region,
wherein each of the plurality of channel structures includes a back electrode layer extending in the first direction and electrically connected to a source region disposed on the substrate, a ferroelectric layer and a channel layer extending in the first direction and sequentially disposed between the back electrode layer and the plurality of word lines in a direction, parallel to an upper surface of the substrate,
wherein, in a program operation for a selected memory cell connected to a selected word line among the plurality of word lines, the peripheral circuit region is configured to input a pass voltage to the selected word line and input a back bias voltage to the back electrode layer from a first point in time, maintain a voltage of the back electrode layer at the back bias voltage during a period from a second point in time to a third point in time after the first point in time, and input the pass voltage to unselected word lines, different from the selected word line after the third point in time.

2. The memory device of claim 1, wherein the peripheral circuit region is configured to perform program loops including the program operation and a program verification operation for the selected memory cell N times, where N is a natural number, and
a first program loop includes the program operation of inputting the pass voltage to the selected word line and inputting the back bias voltage to the back electrode layer.

3. The memory device of claim 2, wherein at least one program loop from a second program loop to an N^{th} program loop includes the program operation of inputting the pass voltage to the selected word line and inputting the back bias voltage to the back electrode layer.

4. The memory device of claim 1, wherein the peripheral circuit region is configured to input a program voltage to the selected word line, and input a ground voltage to the back electrode layer, after the third point in time.

5. The memory device of claim 4, wherein a difference between the pass voltage and the back bias voltage is greater than or equal to the program voltage.

6. The memory device of claim 4, wherein the program voltage is greater than a voltage that inverts a polarization direction of the ferroelectric layer.

7. The memory device of claim 4, wherein the pass voltage is half of the program voltage.

8. The memory device of claim 1, wherein an absolute value of the pass voltage and an absolute value of the back bias voltage are the same.

9. The memory device of claim 1, wherein a difference between the pass voltage and the back bias voltage is greater than or equal to a voltage that inverts a polarization direction of the ferroelectric layer.

10. The memory device of claim 1, wherein the pass voltage is smaller than the voltage that inverts a polarization direction of the ferroelectric layer.

11. The memory device of claim 1, wherein a difference between voltages of the unselected word lines and a voltage of the back electrode layer is equal to or less than the pass voltage, from the third point in time.

12. The memory device of claim 1, wherein the period is 10 nanoseconds or more and 100 nanoseconds or less.

13. The memory device of claim 1, wherein each of the plurality of channel structures includes at least one oxide layer extending in the first direction and disposed between the channel layer and the plurality of word lines in the direction, parallel to the upper surface of the substrate.

14. The memory device of claim 13, wherein the at least one oxide layer includes at least one charge trap layer extending in the first direction and disposed between the channel layer and the plurality of word lines in the direction parallel to the upper surface of the substrate, and trapping charges for storing data.

15. A memory device, comprising:
a cell region including a plurality of word lines stacked on a substrate, and a plurality of channel structures extending in a first direction, perpendicular to the substrate and penetrating through the plurality of word lines; and
a peripheral circuit region including peripheral circuits configured to control the cell region,
wherein each of the plurality of channel structures includes a back electrode layer extending in the first direction and electrically connected to a source region disposed on the substrate, a ferroelectric layer and a channel layer extending in the first direction and sequentially disposed between the back electrode layer and the plurality of word lines in a direction, parallel to an upper surface of the substrate,
wherein, in a program operation for a selected memory cell connected to a selected word line among the plurality of word lines, the peripheral circuit region is configured to input a back bias voltage, lower than a ground voltage to the back electrode layer before inputting a pass voltage to unselected word lines, different from the selected word line, and set a difference between voltages of the unselected word lines and a voltage of the back electrode layer to be less than or equal to the pass voltage.

16. The memory device of claim 15, wherein, before the voltage of the back electrode layer becomes the ground voltage, the pass voltage begins to be input to the unselected word lines.

17. The memory device of claim 15, wherein, after the voltage of the back electrode layer becomes the ground voltage, the pass voltage begins to be input to the unselected word lines.

18. A memory device, comprising:
a cell region including a plurality of word lines stacked on a substrate, and a plurality of channel structures extending in a first direction, perpendicular to the substrate and penetrating through the plurality of word lines; and
a peripheral circuit region including peripheral circuits configured to control the cell region,
wherein each of the plurality of channel structures includes a back electrode layer extending in the first direction and electrically connected to a source region disposed on the substrate, a ferroelectric layer and a channel layer extending in the first direction and sequentially disposed between the back electrode layer and the plurality of word lines in a direction, parallel to an upper surface of the substrate,
wherein, in a write operation for a selected memory cell connected to a selected word line among the plurality of word lines, the peripheral circuit region is configured to input a positive voltage to the selected word line and input a negative voltage to the back electrode layer, while a ground voltage is input to unselected word lines, different from the selected word line, and a difference between the positive voltage and the negative voltage is greater than a voltage, required to invert a polarization direction of the ferroelectric layer of the selected memory cell.

19. The memory device of claim 18, wherein, before the negative voltage is input to the back electrode layer, the positive voltage begins to be input to the selected word line.

20. The memory device of claim 18, wherein, after the negative voltage is input to the back electrode layer, the positive voltage begins to be input to the selected word line.
